(19) United States
(12) Patent Application Publication
(10) Pub. No.: US 2020/0097215 A1
(43) Pub. Date: Mar. 26, 2020

(54) ADAPTIVE SOLID STATE DEVICE MANAGEMENT BASED ON DATA EXPIRATION TIME

(71) Applicant: Western Digital Technologies, Inc., San Jose, CA (US)

(72) Inventors: Alexander Bazarsky, Holon (IL); Alon Marcu, Tel-Mond (IL); Avichay Haim Hodes, Kfar-Ben Nun (IL); Judah Gamliel Hahn, Ofra (IL); Shay Benisty, Beer Sheva (IL); Ariel Navon, Revava (IL)

(21) Appl. No.: 16/141,891

(22) Filed: Sep. 25, 2018

(51) Int. Cl. G06F 3/06

(52) U.S. Cl. CPC G06F 3/0659; G06F 3/0679; G06F 3/0625; G06F 3/0611

(57) ABSTRACT

Aspects of the disclosure provide for managing data storage at a solid state device (SSD) based on an expected storage term (EST) of the data. Methods and apparatus receive, from a host, data to be stored in a non-volatile memory (NVM) of the SSD, determine the EST of the data, select a location in the NVM to store the data based on the EST, and write the data in the selected location. The methods and apparatus may further determine whether the EST has expired, mark the data if the EST has expired, determine whether a time to release (TTR) has arrived after the EST has expired, and delete the marked data after the TTR has arrived or store the data in a different location in the NVM for a term longer than the EST if the TTR has not arrived.

### FIELD

The present disclosure relates generally to solid state data devices (SSDs) including non-volatile memories (NVMs), and more specifically, to methods and apparatus for managing the storage of data at a solid state device based on an expected storage term (EST) of the data.

### INTRODUCTION

In a variety of consumer electronics, solid state devices (SSDs) incorporating non-volatile memories (NVMs) are frequently replacing or supplementing conventional rotating hard disk drives for mass storage. These non-volatile memories may include one or more flash memory devices, such as NAND flash memories, and the flash memory devices may be logically divided into blocks with each of the blocks further divided into logically addressable pages. These logical pages may be any of a variety of sizes (e.g., 512 Bytes, 1 Kilobytes, 2 Kilobytes, 4 Kilobytes).

It would be beneficial to manage data storage in a non-volatile memory of a solid state device (SSD) based on an expected storage term (EST) of the data in order to reduce overall write latency and power consumption of the SSD.

### SUMMARY

According to an aspect of the present disclosure, a method of managing data storage at a data storage apparatus (e.g., SSD) is disclosed. The method includes receiving data to be stored in a non-volatile memory (NVM) of the data storage apparatus, determining an expected storage term (EST) of the data, selecting a location in the NVM to store the data based on the EST, selecting at least one write parameter for writing the data in the selected location based on the EST, and writing the data in the selected location. The method may further include determining whether the EST of the data has expired, marking the data for deletion if the EST has expired, determining whether a time to release (TTR) has arrived after the EST has expired, and deleting the marked data after the TTR has arrived. The method may also include detecting host access to the marked data after the EST has expired, and rewriting, if the TTR has not arrived, accessed data to a different location in the NVM to store the accessed data for a term longer than the EST.

According to another aspect of the disclosure, a data storage apparatus for managing data storage is disclosed. The data storage apparatus, such as a SSD, includes means for receiving data to be stored in a non-volatile memory (NVM) of the data storage apparatus, means for determining an expected storage term (EST) of the data, means for selecting a location in the NVM to store the data based on the EST, means for writing the data in the selected location using a write parameter corresponding to the EST, means for determining whether a mode change indication is received from the host, and means for rewriting, if the mode change indication is received from the host, the data to a different location in the NVM to store the data for a term longer than the EST. The data storage apparatus further includes means for determining whether a time to rewrite the data has past, and means for rewriting, if the time to rewrite has past, the data to a different location in the NVM to store the data for a term longer than the EST. The data storage apparatus also includes means for determining whether the EST of the data has expired, means for marking the data for deletion if the EST has expired, means for determining whether a time to release (TTR) has arrived after the EST has expired, and means for deleting the marked data after the TTR has arrived. The data storage apparatus also includes means for detecting host access to the marked data after the EST has expired, and means for rewriting, if the TTR has not arrived, accessed data to the different location in the NVM to store the accessed data for the term longer than the EST.

According to another aspect, a data storage apparatus (e.g., SSD) is disclosed, which includes a non-volatile memory (NVM) and a controller communicatively coupled to a host device and the NVM. The controller is configured to define a memory space of the NVM as a rewrite buffer, receive, from the host device, data to be stored in the rewrite buffer, write the data in the rewrite buffer using a write parameter derived according to past buffer write statistics, the write parameter corresponding to an expected storage term (EST) of the data, determine whether a time to rewrite the data in the rewrite buffer has past, and rewrite, if the time to rewrite has past, the data within the rewrite buffer to store the data for a term longer than the EST. The controller is further configured to determine whether a mode change indication is received from the host, and rewrite, if the mode change indication is received from the host, the data within the rewrite buffer to store the data for a term longer than the EST. The controller is also configured to derive the write parameter according to the past buffer write statistics, wherein the controller configured to derive is configured to determine whether a time to update buffer parameters has past or whether a write cycle counter has expired, and update the write parameter to the rewrite buffer based on the past buffer write statistics if the time to update the buffer parameters has past or if the write cycle counter has expired.

According to a further aspect, a data storage apparatus (e.g., SSD) is disclosed, which includes a non-volatile memory (NVM) and a controller communicatively coupled to a host device and the NVM. The controller is configured to receive, from the host device, data to be stored in the NVM, determine an expected storage term (EST) of the data, select a location in the NVM to store the data based on the EST, and write the data in the selected location. The controller is further configured to select at least one write parameter for writing the data in the selected location based on the EST. The controller is also configured to determine whether the EST of the data has expired, mark the data if the EST has expired, determine whether a time to release (TTR) has arrived after the EST has expired, and delete the marked data after the TTR has arrived. The controller is further configured to detect host device access to the marked data after the EST has expired, and rewrite, if the TTR has not arrived, accessed data to a different location in the NVM to store the accessed data for a term longer than the EST.

### BRIEF DESCRIPTION OF THE DRAWINGS

FIG. 1 is a block diagram of an exemplary solid state device (SSD) at which the storage of data may be managed in accordance with aspects of the disclosure.

FIG. 2 illustrates a flow diagram of an exemplary method for managing data storage at a SSD in accordance with aspects of the disclosure.

FIG. 3 illustrates a flow diagram of another exemplary method for managing data storage at a SSD in accordance with aspects of the disclosure.

FIG. 4 illustrates a flow diagram of a further exemplary method for managing data storage at a SSD in accordance with aspects of the disclosure.

FIG. 5 illustrates a flow diagram of an example operation for deriving write parameters at a SSD in accordance with aspects of the disclosure.

FIG. 6 illustrates a flow diagram of an exemplary method for managing data storage at a SSD in accordance with aspects of the disclosure.

FIG. 7 illustrates a flow diagram of another exemplary method for managing data storage at a SSD in accordance with aspects of the disclosure.

FIG. 8 illustrates a flow diagram of a further exemplary method for managing data storage at a SSD in accordance with aspects of the disclosure.

FIG. 9 is a block diagram summarizing selected features of an exemplary data storage controller equipped for managing data storage at a SSD in accordance with aspects of the disclosure.

### DETAILED DESCRIPTION

The present disclosure provides methods and apparatus for managing storage at a solid state data device (SSD). In one aspect, the SSD may be a solid state drive. In more detail, a controller may receive data to be stored in a non-volatile memory (NVM) of the SSD and determine an expected storage term (EST) of the data. The controller may further select a location in the NVM to store the data based on the EST and write the data in the selected location. The controller may also determine whether the EST has expired, mark the data if the EST has expired, determine whether a time to release (TTR) has arrived after the EST has expired, and delete the marked data after the TTR has arrived or store the data in a different location in the NVM for a term longer than the EST if the TTR has not arrived.

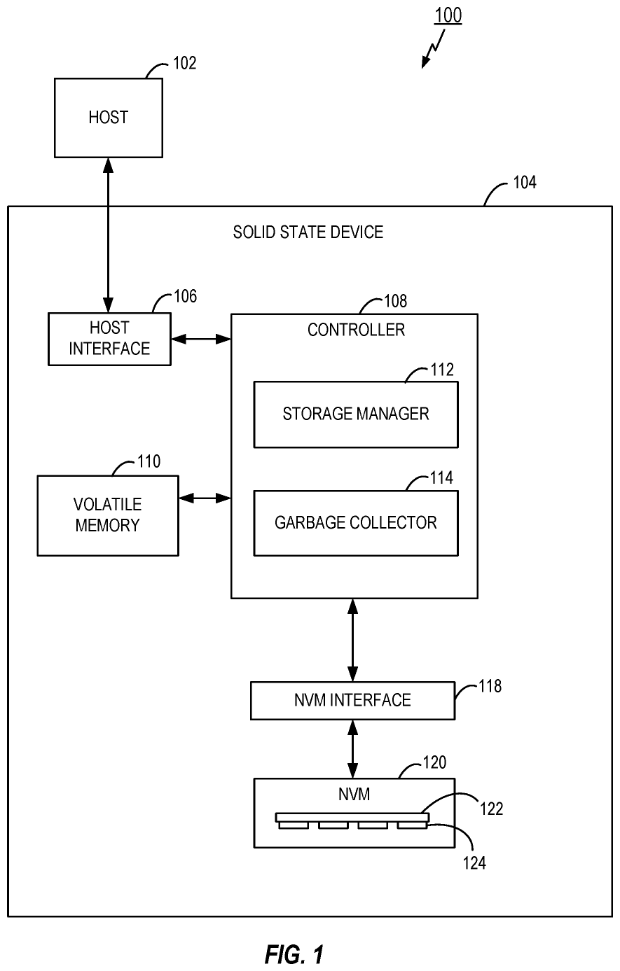

Referring to the drawings, FIG. 1 is a block diagram of a system 100 including an exemplary solid state device (SSD) in which the disclosed managing of data storage may be implemented in accordance with aspects of the disclosure. In one aspect, the SSD may be a solid state drive. The system 100 includes a host 102 and a SSD 104 coupled to the host 102. The host 102 provides commands to the SSD 104 for transferring data between the host 102 and the SSD 104. For example, the host 102 may provide a write command to the SSD 104 for writing data to the SSD 104 or a read command to the SSD 104 for reading data from the SSD 104. The host 102 may be any system or device having a need for data storage or retrieval and a compatible interface for communicating with the SSD 104. For example, the host 102 may be a computing device, a personal computer, a portable computer, a workstation, a server, a personal digital assistant, a digital camera, or a digital phone as merely a few examples.

The SSD 104 includes a host interface 106, a controller 108, a volatile memory 110, a non-volatile memory interface (NVM interface) 118, and a non-volatile memory (NVM) 120, such as a NAND flash memory, for example. In one aspect, the NVM interface 118 may be an interface to flash memory. The host interface 106 is coupled to the controller 108 and facilitates communication between the host 102 and the controller 108. Additionally, the controller 108 is coupled to the volatile memory 110 and coupled to the NVM 120 via the NVM interface 118. The host interface 106 may be any type of communication interface, such as an Integrated Drive Electronics (IDE) interface, a Universal Serial Bus (USB) interface, a Serial Peripheral (SP) interface, an Advanced Technology Attachment (ATA) or Serial Advanced Technology Attachment (SATA) interface, a Small Computer System Interface (SCSI), an IEEE 1394 (Firewire) interface, or the like. In some embodiments, the host 102 includes the SSD 104. In other embodiments, the SSD 104 is remote with respect to the host 102 or is contained in a remote computing system communicatively coupled with the host 102. For example, the host 102 may communicate with the SSD 104 through a wireless communication link.

The controller 108 controls operation of the SSD 104. In various aspects, the controller 108 receives commands from the host 102 through the host interface 106 and performs the commands to transfer data between the host 102 and the NVM 120. Furthermore, the controller 108 may manage reading from and writing to the volatile memory 110 for performing the various functions effected by the controller and to maintain and manage cached information stored in the volatile memory 110. The controller may include a storage manager device (or circuit/module) 112 that manages the storage of data in the NVM 120 (e.g., based on an expected storage term (EST) of the data). The controller 108 may also include a garbage collector device (or circuit/module) 114 that copies valid data into new or free areas and erases invalid data in physical block locations of the NVM 120 in order to free invalid memory space.

The controller 108 may include any type of processing device, such as a microprocessor, a microcontroller, an embedded controller, a logic circuit, software, firmware, or the like, for controlling operation of the SSD 104. In some aspects, some or all of the functions described herein as being performed by the controller 108 may instead be performed by another element of the SSD 104. For example, the SSD 104 may include a microprocessor, a microcontroller, an embedded controller, a logic circuit, software, firmware, or any kind of processing device, for performing one or more of the functions described herein as being performed by the controller 108. According to other aspects, one or more of the functions described herein as being performed by the controller 108 are instead performed by the host 102. In still further aspects, some or all of the functions described herein as being performed by the controller 108 may instead be performed by another element such as a controller in a hybrid drive including both non-volatile memory elements and magnetic storage elements.

The volatile memory 110 may be any memory, computing device, or system capable of storing data. For example, the volatile memory 110 may be a random-access memory (RAM), a dynamic random-access memory (DRAM), a double data rate (DDR) DRAM, a static random-access memory (SRAM), a synchronous dynamic random-access memory (SDRAM), a flash storage, an erasable programmable read-only-memory (EPROM), an electrically erasable programmable read-only-memory (EEPROM), or the like. In various embodiments, the controller 108 uses the volatile memory 110, or a portion thereof, to store data during the transfer of data between the host 102 and the NVM 120. For example, the volatile memory 110 or a portion of the volatile memory 110 may be a cache memory.

The NVM 120 receives data from the controller 108 via the NVM interface 118 and stores the data. The NVM 120 may be any type of non-volatile memory, such as a flash storage system, a NAND-type flash memory, a solid state data storage device, a flash memory card, a secure digital (SD) card, a universal serial bus (USB) memory device, a CompactFlash card, a SmartMedia device, a flash storage array, or the like. The NVM 120 may include one or more memory modules 122, wherein one or more memory dies 124 are formed as part of a memory module 122.

The controller 108 (including the storage manager 112 and the garbage collector 114), the NVM interface 118, and/or the NVM 120 can be configured to perform any of the processes described herein for managing data storage in a SSD.

A NVM device may be configured for data retention (DR). DR allows the NVM device to store data for a minimum amount of time without power. The NVM device may further be configured to perform a minimum number of program/erase (P/E) cycles before ceasing to reliably store data. An operation performed by the NVM device for storing data may be similar for all types of written data. The NVM device may write the data into more reliable single level cell (SLC) memory or less reliable triple level cell (TLC) memory, but an overall configuration of the device may be derived from the TLC memory.

According to certain aspects, different hosts may use the NVM device for purposes other than a long-term storage of data. That is, hosts may use the NVM device to store temporary data, i.e., data that is not meant to be stored indefinitely. For example, automotive devices and surveillance devices may be configured with a time for when stored data will be overwritten. In another example, for SSDs not having adequate space in RAM, the stored data may be flushed from the storage device and later restored. As such, a configuration regarding data retention (DR) or P/E cycles may not apply. In a further example, a computer's recycle bin may have a large volume and an expiration date. Cache data stored by web browsers is another example of temporary data with an expiration date. In general, information emanating from the Internet and displayed using a web browser has an embedded valid expiration date. Upon expiration, the web browser is expected to re-fetch the information from the web server. The expiration date may be an explicit date usually provided with high resolution (days, weeks, or months).

In the examples above, NVM resources may be unnecessarily wasted, as a NVM device is not aware of the reduced configuration of the short-term data expiration, and will treat all data with the same level of importance. Accordingly, what is needed is a system and/or method for optimally managing data storage at a data storage device (e.g., SSD) that takes into account a data expiration term, time, and/or date.

Aspects of the present disclosure relate to managing data storage in a device based on an expected storage term (EST) of the data. The device may change read/write properties and internal management procedures according to the EST of input data. Aspects of the disclosure may be implemented in different host types, such as SSDs, automotive NVMs (e.g., memory devices connected to automotive cars), and Internet of Things (IoT) devices (that allow data from different sensors to be treated in a different manner). Accordingly, a system solution may be provided that benefits device endurance, throughput, and power consumption. In an aspect, a device may estimate the EST of data based on machine-learning.

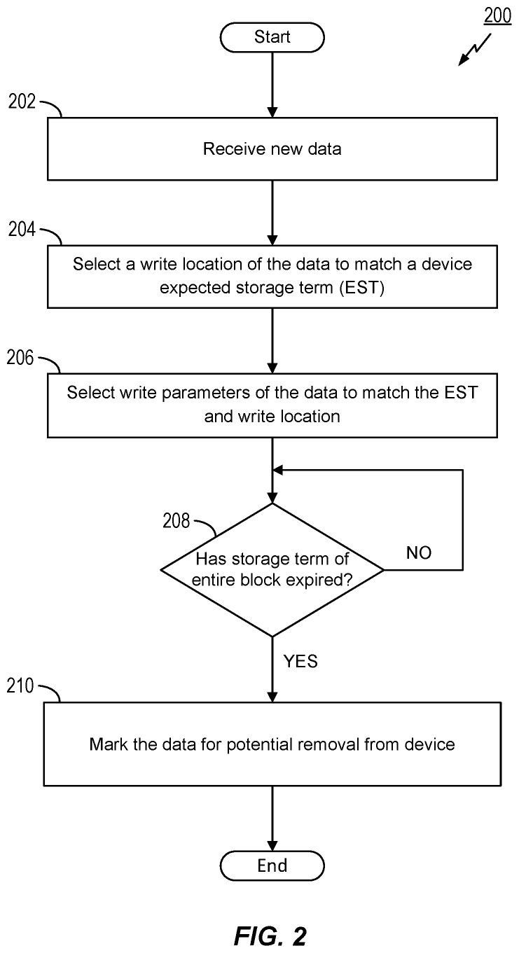

FIG. 2 illustrates a flow diagram 200 of an exemplary method for managing data storage at a data storage apparatus, such as a solid state device (SSD), in accordance with aspects of the disclosure. In one aspect, the SSD may be a solid state drive. The method 200 may be performed by a controller (e.g., controller 108). In an aspect, the method relates to modifying storage parameters according to an expected storage term (EST).

The method 200 includes receiving new data to be stored as shown at block 202.

The method 200 further includes selecting a write location of the data according to a device EST as shown at block 204. In an aspect, several groups of memory blocks may be created where “worse” blocks may be assigned to contain data with a shorter EST. A “worse” block may be a block that has experienced a high number of program/erase (P/E) cycles and/or has a higher error rate. A “better” block is expected to have a lower error rate, and therefore, such block may be assigned to contain data with a longer EST. Moreover, wordlines (WLs) within a same block may vary in reliability. As such, WLs with a lower reliability may be used to store data with a shorter EST.

In an aspect, the EST may be determined by a host and supplied to the controller of the SSD. In a further aspect, an operating system may have different thresholds (e.g., predetermined terms) set for the EST. For example, a recycle bin may have a threshold of keeping data for a number of months (e.g., one month, two months, etc.). In another example, a temporary Internet buffer may have a certain size, and therefore, old data may be discarded to make room for new data if the buffer has reached a maximum capacity.

In an aspect, a storage device may machine-learn an optimal storage term for different types of hosts and determine an EST accordingly. In automotive devices, which are storage devices embedded in car, a car maker may be able to determine the optimal storage term. For example, the car may record sensor data. The car does not need to store the raw data itself, just the aggregations on that data (aggregated data). Accordingly, the car (e.g., via an automotive controller) may supply the raw data with a short expected storage term, and the aggregated data may be kept indefinitely, which improves the system.

The method 200 further includes selecting write parameters of the data according to the EST of the data and the write location as shown at block 206. In an aspect, when writing data to the NVM device, a different number of pulses are used when a voltage is applied. For example, to write data to 5 volts, such as when the controller intends to have a flash transistor keep the data for a long term, the controller may need to verify that the data is indeed written to 5 volts. To verify, after writing the data, the controller may perform a read operation to ensure that enough data bits have reached a state to which the controller is programming.

In an aspect, after writing the data, a verify pulse may be used to verify that the data has indeed reached a written state. A number of verify pulses used may be important if the data is to be kept for a longer time. For example, in order for the data to be written with a low bit error rate, the controller should use as many verify pulses as possible.

In an aspect, if the data is only to be stored for a short while based on the EST, then the number of verify pulses used may be lowered and the data may be written with a higher bit error rate. For example, the number of verify pulses used during the writing of data influences a total bit error rate (BER) of the written data. If this data is only required to be stored for a short while, it may be allowed to use less verify pulses, thus shortening a write duration and overall power consumption of the write process. Another write parameter modification may relate to a voltage window (range of voltages) used to program a memory block. Lowering a voltage span decreases a distance and distinction between written states, and increases the BER of read data. On the other hand, using a smaller voltage window decreases wear (i.e., lessens stress on the memory block and the flash drive) and increases endurance.

The method 200 further includes determining whether a storage term of an entire memory block has expired as shown at block 208. In an aspect, during background or garbage collection operations, the controller may occasionally poll whether some data is “overdue” and act accordingly. The EST may be written into an L2P table (table that connects a logical block to a physical block) itself or may be arranged at memory block level, on a lower resolution. In the latter case, the longest EST will govern the EST assigned to the entire memory block if there is variance of EST within the memory block. After a Time to Release (TTR) has arrived, which is a predetermined time past the expiration of the EST, the data is considered to be potentially unreadable.

The method 200 also includes marking the data for potential removal/deletion from the device as shown at block 210. In an aspect, once the EST has been defined, the data may be removed from the NVM device. Block 210 includes the potential deletion of data after the TTR has arrived. The deletion may or may not be performed to potentially allow a host to correct a mistake. The deletion of data will release the memory block into a free block pool and potentially increase the throughput of the device, as it will take longer to reach a fully written device state. Moreover, garbage collection in this case may be postponed. If the host requests data that was deleted due to an expiration date, a specific error message may be returned to the host. However, if the data with an EST was accessed after the EST expired but before the TTR has arrived, the data may be relocated and rewritten.

In an aspect, the method 200 may work well with temporary data, wherein an EST changes rapidly between different types of data. For example, a consumer laptop used to surf the web, process numerous files, and delete such files, may benefit from the scheme of the method 200 as the EST can be determined for each data segment.

In a further aspect, while not explicitly noted in FIG. 2, the system may use EST in its maintenance by modifying a relocation (read-scrub) mechanism. If a memory block contains only data with a short EST, the controller may avoid relocating the data, or may use different threshold parameters when relocating the data. The TTR and the EST may both be considered in the relocation mechanism, and relocation candidates may be ordered according to a weighting between the EST and the TTR.

In an aspect, data deletion in a NVM device is memory block-based. Chunks of data that are smaller than a memory block cannot be deleted. Accordingly, garbage collection may be enabled to facilitate the data deletion. Garbage collection is a management operation that collects sparsely written data and gathers the data into a memory block. Thus, chunks of data that were not entirely deleted may be placed into a whole memory block (e.g., a new memory block). Afterward, the memory block that was freed of the sparsely written data may be deleted. In addition, when performing garbage collection, the device may consider the EST and the TTR when marking “victim” blocks for relocation. The EST may be used to consider whether the controller still intends to relocate the data, or just wishes to leave the data in the memory block until the EST passes, and thereafter, delete/invalidate the entire memory block. The validity of data in such memory blocks may be weighted according to the time remaining in the EST or until the TTR has arrived.

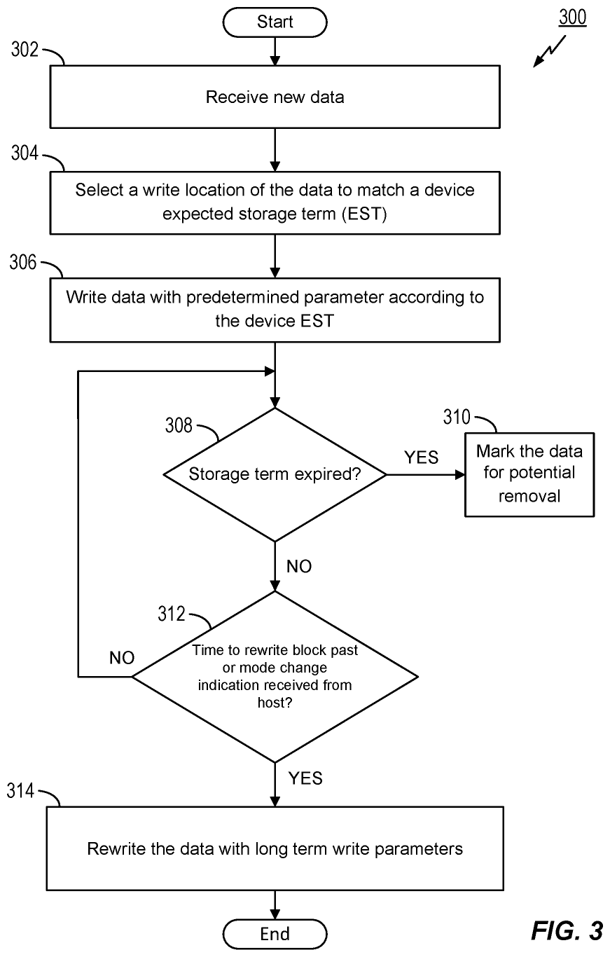

FIG. 3 illustrates a flow diagram 300 of another exemplary method for managing data storage at a data storage apparatus, such as a SSD, in accordance with aspects of the disclosure. In one aspect, the SSD may be a solid state drive. The method 300 may be performed by a controller (e.g., controller 108). In an aspect, the method relates to the use of EST in devices with an expiration date associated with the nature of the device itself.

In an aspect, IoT devices, such as surveillance cameras may overwrite an entire device within days. Hence, when data is written, the amount of time needed to overwrite the entire device may be considered. However, if the writing of data has ceased, this may indicate that the data is awaiting to be recovered. In this case, an initial write mode that intended for the data to be kept for several months may not produce reliable read data after that term. The data may be rewritten if a long stall in write has been detected. A change of operation mode (MC) may also be requested by the host. When the host decides that it needs to read data written in the last few days, the host may pass a command to the device which will rewrite the needed data to store the data for a longer time. If data with an EST was accessed after the EST expired but before the TTR has arrived, the data may also be relocated.

The method 300 includes receiving new data to be stored as shown at block 302. The method 300 further includes selecting a write location of the data according to a device EST as shown at block 304. The EST may be defined for the entire device. Thus, there may be no need for an input EST from the host.

The method 300 further includes writing the data with a predetermined parameter according to the device EST as shown at block 306. For example, the controller may first write the data in a “dirty” way. That is, the data may be written in a fast or reckless manner, which may cause damage to the data. Later, if the controller decides to keep the data for a longer period of time, the data may be handled with more care. Accordingly, the data may be rewritten in a “clean” way. That is, the data may be rewritten in a different/better block with better programming characteristics using write parameters for storing data over a long period of time.

The method 300 further includes determining whether a storage term has expired as shown at block 308 (e.g., determining whether the EST expired and/or the TTR (which is past the expiration of the EST) has arrived). If the storage term has expired, the method 300 includes marking the data for potential removal/deletion from the device as shown at block 310.

If the storage term has not expired, the method 300 includes determining whether a time to rewrite a memory block has past or whether a mode change indication has been received from the host as shown at block 312. If the time to rewrite the memory block has past or if the mode change indication has been received from the host, the method 300 includes rewriting the data with long term write parameters as shown at block 314. That is, the data is rewritten in a different/better block using write parameters for storing the data over a long period of time.

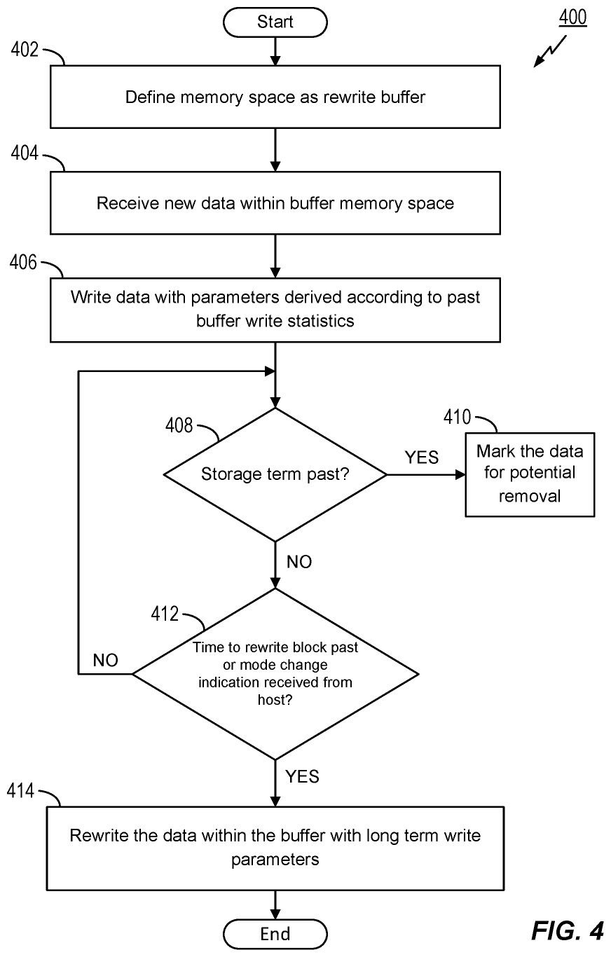

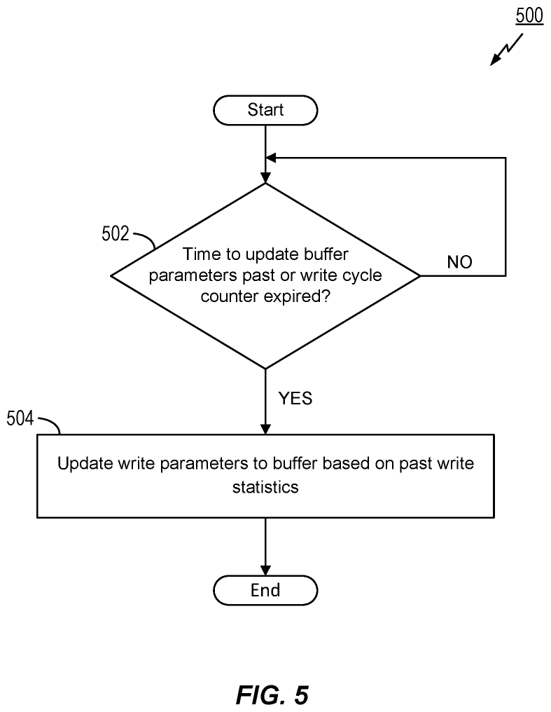

FIG. 4 illustrates a flow diagram 400 of a further exemplary method for managing data storage at data storage apparatus, such as a SSD, in accordance with aspects of the disclosure. In one aspect, the SSD may be a solid state drive. The method 400 may be performed by a controller (e.g., controller 108). FIG. 5 illustrates a flow diagram 500 of an example operation for deriving write parameters at a data storage apparatus, such as a SSD (or solid state drive), in accordance with aspects of the disclosure. The method 500 may be performed by the controller (e.g., controller 108). In an aspect, the methods 400 and 500 relate to the use of EST in a device that employs a cyclic buffer which is read/write intensive. The device may be constantly rewritten and average statistics may be used to acquire write parameters suitable to a memory range of the device.

In an aspect, a memory block may be replaced if the EST has expired and the data has not been rewritten. The activation of device operation in this mode may be enabled and acknowledged by the host. The EST may be modified by an external event, without host indication. An example of such behavior may be a swap partition operation, which may be used to enhance the performance of the host RAM. In this case, whenever a host executes a power cycle, an entire buffer may be deleted.

In an aspect, the EST may be dependent on an external event. For example, the EST may depend on a host executing a power cycle. Whenever the host executes a power cycle, such event may define a length of the EST. A device may use past statistics of when the host executed the power cycle, and therefore, memory blocks and the data to be stored within the memory blocks may be handled based on such event.

In another aspect, the EST may depend on statistics regarding how long the host rewrites data. A controller may know whatever the host is reading and writing, and therefore, the controller may know how often the host rewrites the memory space. For example, a surveillance camera may write a memory space of 10 MB very rapidly (e.g., all the time). The camera goes off and on very seldom. Moreover, the camera may rewrite the same memory space in a span of minutes (e.g., every 20 minutes). Accordingly, the controller may determine that the camera does not retain the data longer than 20 minutes. As such, the EST may be based on this span of time.

The method 400 includes defining a memory space as a rewrite buffer as shown at block 402. In an aspect, the memory space may be identified as a write intensive buffer or defined as such by the host. The method 400 also includes receiving new data within the buffer memory space as shown at block 404.

The method 400 further includes writing the data with parameters derived according to past buffer write statistics. The derivation of these parameters is expanded in the method 500 of FIG. 5, which shows a mechanism that updates the write parameters, by either passing a write cycle threshold or a time threshold. As shown in FIG. 5, the method 500 includes determining whether a time to update buffer parameters has past or a write cycles counter has expired as shown at block 502. If yes, the method 500 further includes updating the write parameters to the buffer based on the past write statistics as shown at block 504. The past write statistics may include a time between write cycles and a read frequency of the buffer.

Referring back to FIG. 4, the method 400 further includes determining whether a storage term has expired (e.g., determining whether the EST has expired and/or the TTR has arrived). If the storage term has expired, the method 400 includes marking the data for potential removal/deletion from the buffer as shown at block 410.

If the storage term has not expired, the method 400 includes determining whether a time to rewrite a memory block has past or whether a mode change indication has been received from the host as shown at block 412. If the time to rewrite the memory block has past or if the mode change indication has been received from the host, the method 400 includes rewriting the data within the buffer with long term write parameters as shown at block 414. That is, the data is rewritten using write parameters for storing the data over a long period of time. As described above, the modification of write parameters may be used as a means to reduce write latency and power when the EST is a short period of time.

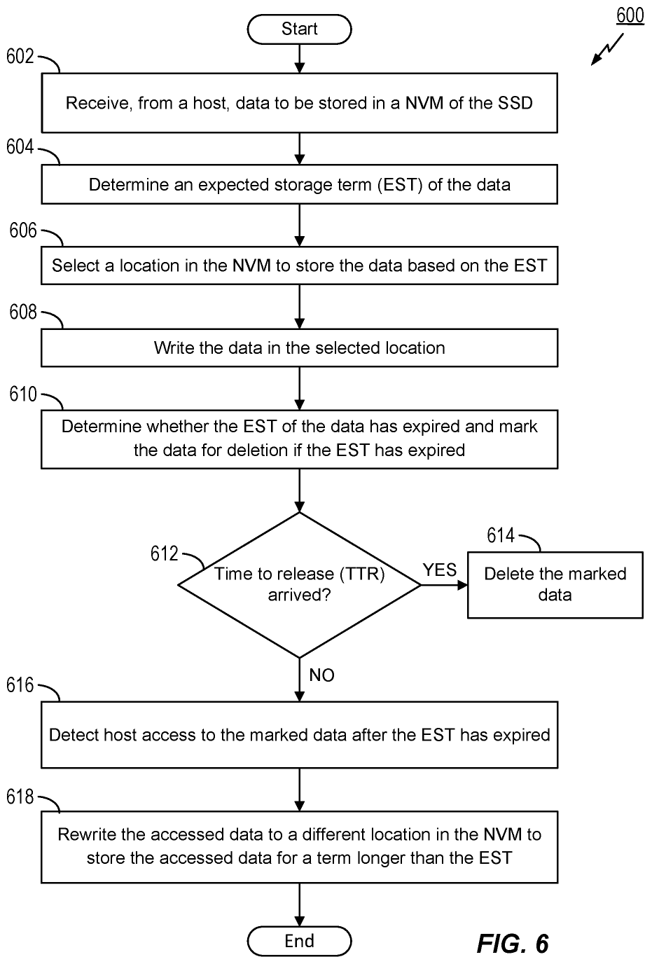

FIG. 6 illustrates a flow diagram of an exemplary method 600 for managing data storage in a data storage apparatus (e.g., SSD). The SSD may be a solid state drive. The method 600 may be performed by a controller (e.g., controller 108).

The method 600 includes receiving data (e.g. from a host 102) to be stored in a non-volatile memory (NVM) (e.g., NVM 120) of the SSD as shown at block 602. The method 600 also includes determining an expected storage term (EST) of the data as shown at block 604. In an aspect, the EST may be determined by the host and supplied to the controller. In a further aspect, the EST may be determined by the controller itself.

The method 600 includes selecting a location in the NVM to store the data based on the EST as shown at block 606. In an aspect, selecting the location may include selecting a location with a high error rate if the EST has a length less than a predetermined term (i.e., shorter EST). In another aspect, the selecting the location includes selecting a location with a low error rate if the EST has a length equal to or greater than the predetermined term (i.e., longer EST).

The method 600 further includes writing the data in the selected location as shown at block 608. In an aspect, writing the data may include selecting at least one write parameter for writing the data in the selected location based on the EST. The at least one write parameter may include a number of verify pulses used during the writing of the data and/or a difference between the highest voltage and the lowest voltage in a range of voltages (e.g., size of a voltage window) used during the writing of the data. In one aspect, the highest voltage corresponds to the voltage level of the highest written state, and the lowest voltage corresponds to the voltage level of the lowest written state.

The method 600 includes determining whether the EST of the data has expired and marking the data for deletion if the EST has expired as shown at block 610. The method 600 then determines whether a time to release (TTR) has arrived after the EST has expired as shown at block 612. If the TTR has arrived, the method 600 includes deleting the marked data as shown at block 614.

If the TTR has not arrived, the method 600 includes detecting host access to the marked data after the EST has expired as shown at block 616. Thereafter, the method 600 rewrites accessed data to a different location in the NVM to store the accessed data for a term longer than the EST as shown at block 618.

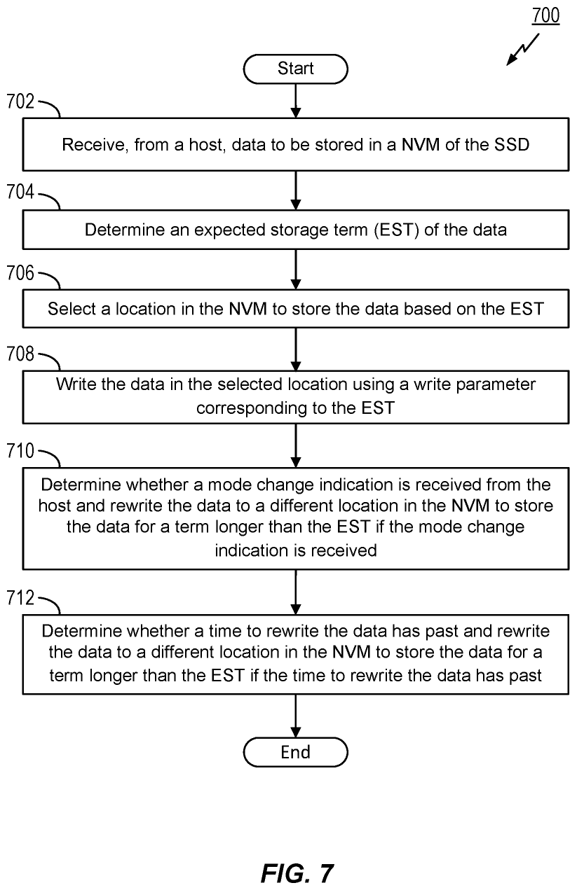

FIG. 7 illustrates a flow diagram of an exemplary method 700 for managing data storage in a data storage apparatus (e.g., SSD). The SSD may be a solid state drive. The method 700 may be performed by a controller (e.g., controller 108).

The method 700 includes receiving (e.g. from a host 102) data to be stored in a non-volatile memory (NVM) (e.g., NVM 120) of the SSD as shown at block 702. The method 700 also includes determining an expected storage term (EST) of the data as shown at block 704. In an aspect, the EST may be determined by the host and supplied to the controller. In a further aspect, the EST may be determined by the controller itself.

The method 700 includes selecting a location in the NVM to store the data based on the EST as shown at block 706. In an aspect, selecting the location may include selecting a location with a high error rate if the EST has a length less than a predetermined term (i.e., shorter EST). In another aspect, the selecting the location includes selecting a location with a low error rate if the EST has a length equal to or greater than the predetermined term (i.e., longer EST). The method 700 further includes writing the data in the selected location using a write parameter corresponding to the EST as shown at block 708.

The method 700 also includes determining whether a mode change indication is received from the host, and if the mode change indication is received, rewriting the data to a different location in the NVM to store the data for a term longer than the EST as shown at block 710. The method 700 further includes determining whether a time to rewrite the data has past, and if the time to rewrite has past, rewriting the data to the different location in the NVM to store the data for the term longer than the EST as shown at block 712. In an aspect, the data is rewritten to the different location using a different write parameter corresponding to the term longer than the EST.

In an aspect, the method 700 may operate in conjunction with some or all of the features described with respect to the method 600 of FIG. 6. For example, the method 700 may also include the features of blocks 610, 612, 614, 616, and 618 of the method 600. Accordingly, the method 700 may include determining whether the EST of the data has expired and marking the data for deletion if the EST has expired (block 610). The method 700 may then determine whether a time to release (TTR) has arrived after the EST has expired (block 612). If the TTR has arrived, the method 700 deletes the marked data (block 614). If the TTR has not arrived, the method 700 includes detecting host access to the marked data after the EST has expired (block 616). Thereafter, the method 700 rewrites accessed data to a different location in the NVM to store the accessed data for a term longer than the EST (block 618).

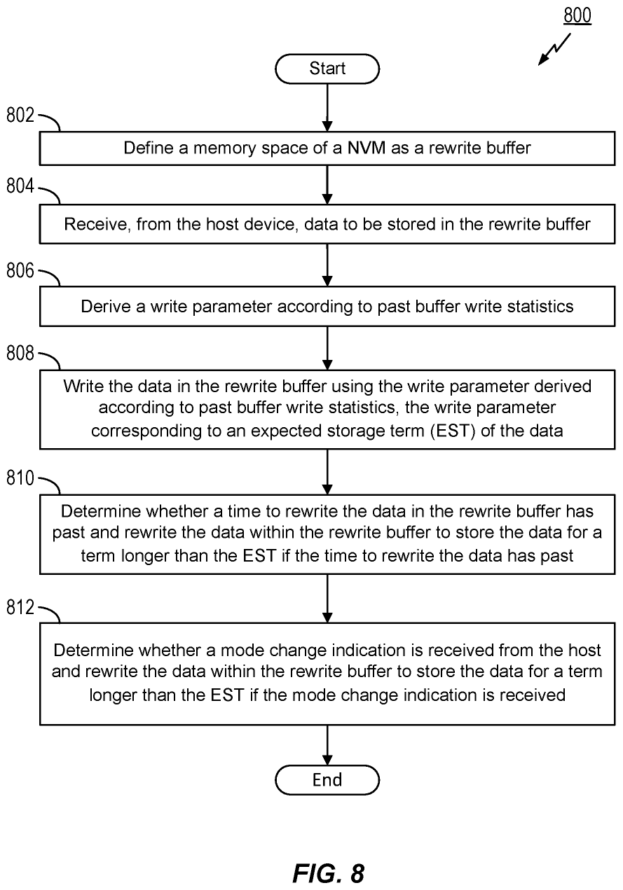

FIG. 8 illustrates a flow diagram of an exemplary method 800 for managing data storage in a data storage apparatus (e.g., SSD). The SSD may be a solid state drive. The method 800 may be performed by a controller (e.g., controller 108).

The method 800 includes defining a memory space of a non-volatile memory (NVM) (e.g., NVM 120) of the SSD as a rewrite buffer as shown at block 802. The method 800 also includes receiving, from a host device (e.g. host 102), data to be stored in the rewrite buffer as shown at block 804.

The method 800 further includes deriving a write parameter according to the past buffer write statistics as shown at block 806. In an aspect, deriving the write parameter includes determining whether a time to update buffer parameters has past or whether a write cycle counter has expired, and updating the write parameter to the rewrite buffer based on the past buffer write statistics if the time to update the buffer parameters has past or if the write cycle counter has expired.

The method 800 includes writing the data in the rewrite buffer using the write parameter derived according to the past buffer write statistics as shown at block 808. The write parameter may correspond to an expected storage term (EST) of the data.

The method 800 also includes determining whether a time to rewrite the data in the rewrite buffer has past, and if the time to rewrite has past, rewriting the data within the rewrite buffer to store the data for a term longer than the EST as shown at block 810. The method 800 further includes determining whether a mode change indication is received from the host, and if the mode change indication is received from the host, rewriting the data within the rewrite buffer to store the data for the term longer than the EST as shown at block 812. In an aspect, the data is rewritten within the rewrite buffer using a different write parameter corresponding to the term longer than the EST.

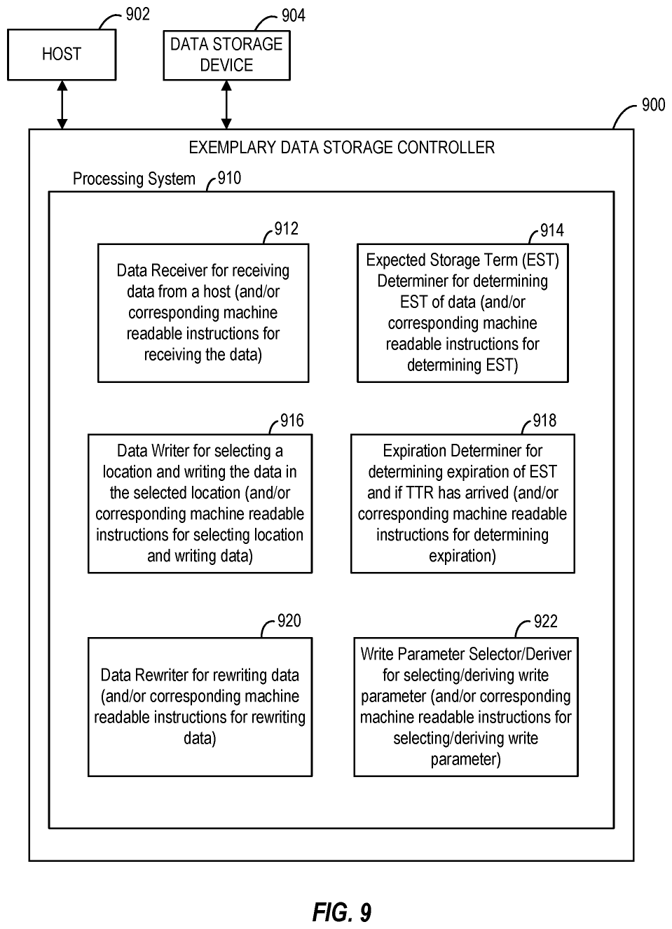

FIG. 9 is a block diagram summarizing selected features of an exemplary data storage controller 900 equipped for managing data storage at a data storage apparatus (e.g., SSD or solid state drive) in accordance with aspects of the disclosure. The data storage controller 900 may be configured to communicate with a host device 902 and a data storage device (e.g., SSD) 904. Although many examples described herein relate to NVM controllers or flash controllers for executing operations in conjunction with flash dies, the data storage device 904 may be any suitable memory or storage device and is not limited to NVM devices, and the data storage controller 900 may be any suitable memory controller device and is not limited to NVM-based controllers.

The exemplary data storage controller 900 of FIG. 9 includes a processor 910 (e.g., processing system/circuitry). The processor 910 includes a data receiver 912 configured to receive, from the host device 902, data to be stored in the data storage device 904. The processor 910 also includes an expected storage term (EST) determiner 914 configured to determine the EST of the data. The processor 910 further includes a data writer 916 configured to selecting a location in the data storage device 904 to store the data based on the EST and write the data in the selected location. The processor 910 also includes an expiration determiner 918 configured to determine whether the EST of the data has expired and determine whether a time to release (TTR) has arrived after the EST has expired. The processor 910 further includes a data rewriter 920 configured to rewrite the data to a different location (or within a rewrite buffer) in the data storage device 904 to store the data for a term longer than the EST. The processor 910 also includes a write parameter selector/deriver 922 configured to select/derive a write parameter.

In at least some examples, means may be provided for performing the functions illustrated in FIGS. 2-8 and/or other functions illustrated (such as those described with respect to FIG. 1) or described herein. For example, an apparatus (e.g. processing system 910) may be provided for use with a host device (e.g., host 902) and a data storage device (e.g., storage device 904), where the apparatus includes: means (such as the data receiver 912) for receiving, from the host 902, data to be stored in the data storage device 904; means (such as the EST determiner 914) for determining an expected storage term (EST) of the data; means (such as the data writer 916) for selecting a location in the data storage device 904 to store the data based on the EST; means (such as the data writer 916) for writing the data in the selected location; means (such as the write parameter selector/deriver 922) for selecting at least one write parameter for writing the data in the selected location based on the EST; means (such as the expiration determiner 918) for determining whether the EST of the data has expired and marking the data for deletion if the EST has expired; means (such as the expiration determiner 918) for determining whether a time to release (TTR) has arrived after the EST has expired and deleting the marked data after the TTR has arrived; and means (such as the data rewriter 920) for detecting host access to the marked data after the EST has expired, and if the TTR has not arrived, rewriting accessed data to a different location in the data storage device 904 to store the accessed data for a term longer than the EST.

In another example, the apparatus includes: means (such as the data writer 916) for writing the data in the selected location using a write parameter corresponding to the EST; means (such as the data rewriter 920) for determining whether a mode change indication is received from the host device 902, and if the mode change indication is received from the host 902, rewriting the data to a different location in the data storage device 904 to store the data for a term longer than the EST; and means (such as the data rewriter 920) for determining whether a time to rewrite the data has past, and if the time to rewrite has past, rewriting the data to a different location in the data storage device 904 to store the data for a term longer than the EST.

In a further example, the apparatus includes: means (such as the data writer 916) for defining a memory space of the data storage device 904 as a rewrite buffer; means (such as the data receiver 912) for receiving, from the host device 902, data to be stored in the rewrite buffer; means (such as the data writer 916) for writing the data in the rewrite buffer using a write parameter derived according to past buffer write statistics, the write parameter corresponding to an expected storage term (EST) of the data; means (such as the data rewriter 920) for determining whether a time to rewrite the data in the rewrite buffer has past, and if the time to rewrite has past, rewriting the data within the rewrite buffer to store the data for a term longer than the EST; means (such as the data rewriter 920) for determining whether a mode change indication is received from the host, and if the mode change indication is received from the host, rewriting the data within the rewrite buffer to store the data for a term longer than the EST; and means (such as the write parameter selector/deriver 922) for deriving the write parameter according to the past buffer write statistics.

In one aspect, means for performing some of the functions described above may also be found in FIG. 1.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

What is claimed is:

1. A data storage apparatus, comprising:
a non-volatile memory (NVM); and
a controller communicatively coupled to a host device and the NVM, wherein the controller is configured to:
receive data to be stored in the NVM,
determine an expected storage term (EST) of the data,
select a location in the NVM to store the data based on the EST, and
write the data in the selected location.

2. The data storage apparatus of claim 1, wherein the controller configured to select the location is configured to:
select a location with a high error rate if the EST has a length less than a predetermined term; and
select a location with a low error rate if the EST has a length equal to or greater than the predetermined term.

3. The data storage apparatus of claim 1, wherein the controller is further configured to select at least one write parameter for writing the data in the selected location based on the EST.

4. The data storage apparatus of claim 3, wherein the at least one write parameter comprises:
a number of verify pulses used during the writing of the data.

5. The data storage apparatus of claim 3, wherein the at least one write parameter comprises:
a difference between a highest voltage and a lowest voltage in a range of voltages used during the writing of the data.

6. A method of managing data storage at a data storage apparatus, comprising:
receiving data to be stored in a non-volatile memory (NVM) of the data storage apparatus;
determining an expected storage term (EST) of the data;
selecting a location in the NVM to store the data based on the EST; and
writing the data in the selected location.

7. The method of claim 6, further comprising:
determining whether the EST of the data has expired; and
marking the data for deletion if the EST has expired.

8. The method of claim 7, further comprising:
determining whether a time to release (TTR) has arrived after the EST has expired; and
deleting the marked data after the TTR has arrived.

9. The method of claim 7, further comprising:
detecting host access to the marked data after the EST has expired; and
rewriting, if the TTR has not arrived, accessed data to a different location in the NVM to store the accessed data for a term longer than the EST.

10. A data storage apparatus for managing data storage, comprising:
means for receiving data to be stored in a non-volatile memory (NVM) of the data storage apparatus;
means for determining an expected storage term (EST) of the data;
means for selecting a location in the NVM to store the data based on the EST;
means for writing the data in the selected location using a write parameter corresponding to the EST;
means for determining whether a mode change indication is received from a host; and
means for rewriting, if the mode change indication is received from the host, the data to a different location in the NVM to store the data for a term longer than the EST.

11. The data storage apparatus of claim 10, wherein the data is rewritten to the different location using a different write parameter corresponding to the term longer than the EST.

12. The data storage apparatus of claim 10, further comprising:
means for determining whether a time to rewrite the data has past; and
means for rewriting, if the time to rewrite has past, the data to a different location in the NVM to store the data for a term longer than the EST.

13. The data storage apparatus of claim 10, further comprising:
means for determining whether the EST of the data has expired;
means for marking the data for deletion if the EST has expired;
means for determining whether a time to release (TTR) has arrived after the EST has expired; and
means for deleting the marked data after the TTR has arrived.

14. The data storage apparatus of claim 13, further comprising:
means for detecting host access to the marked data after the EST has expired; and
means for rewriting, if the TTR has not arrived, accessed data to the different location in the NVM to store the accessed data for the term longer than the EST.

15. A data storage apparatus, comprising:
a non-volatile memory (NVM); and
a controller communicatively coupled to a host device and the NVM, wherein the controller is configured to:
define a memory space of the NVM as a rewrite buffer,
receive data to be stored in the rewrite buffer,
write the data in the rewrite buffer using a write parameter, the write parameter corresponding to an expected storage term (EST) of the data,
determine whether a time to rewrite the data in the rewrite buffer has past, and
rewrite, if the time to rewrite has past, the data within the rewrite buffer to store the data for a term longer than the EST.

16. The data storage apparatus of claim 15, wherein the data is rewritten within the rewrite buffer using a different write parameter corresponding to the term longer than the EST.

17. The data storage apparatus of claim 15, wherein the controller is further configured to:
determine whether a mode change indication is received from the host device; and
rewrite, if the mode change indication is received from the host device, the data within the rewrite buffer to store the data for a term longer than the EST.

18. The data storage apparatus of claim 15, wherein the controller is further configured to derive the write parameter according to past buffer write statistics.

19. The data storage apparatus of claim 18, wherein the controller further configured to derive is configured to:
determine whether a time to update buffer parameters has past; and
update, if the time to update the buffer parameters has past, the write parameter to the rewrite buffer based on the past buffer write statistics.

20. The data storage apparatus of claim 18, wherein the controller further configured to derive is configured to:
determine whether a write cycle counter has expired; and
update, if the write cycle counter has expired, the write parameter to the rewrite buffer based on the past buffer write statistics.
